(19) United States
(12) Patent Application Publication
(10) Pub. No.: US 2021/0008746 A1
(43) Pub. Date: Jan. 14, 2021

(54) SAFETY RAZOR SHAVING SYSTEM

(71) Applicant: BEIERSDORF AG, Hamburg (DE)

(72) Inventors: Alexander KRÜMKE, Hamburg (DE); Peter MAURER, Neumuenster (DE); Michaela KOHUT, Hamburg (DE); Frank HETZEL, Welle (DE); Jelte STEUR, Oudehaske (NL); Arif VEENDIJK, Assen (NL); Johannes Rogier DE VRIND, Haren (NL); Patje SANDER, Groningen (NL)

(21) Appl. No.: 16/979,986

(22) PCT Filed: Dec. 18, 2018
(86) PCT No.: PCT/EP2018/085397

§ 371 Date: Sep. 11, 2020

(30) Foreign Application Priority Data
Mar. 13, 2018 (DE) 10 2018 105 823.3

(51) Int. Cl. B26B 21/52; B26B 21/22

(52) U.S. Cl. CPC B26B 21/521; B26B 21/4018; B26B 21/22

(57) ABSTRACT

A safety razor shaving system, comprising: a handle; a replaceable razor cartridge; and a base plate comprising an elongate frame surrounding at least one hole, wherein the elongate frame is connected to the handle and provided with engaging elements on either short side portion, the engaging elements of the elongate frame configured to releasably engage complementary engaging elements of the replaceable razor cartridge.

### FIELD

The invention relates to safety shaving razor systems and, more particularly, to structures for connecting a replaceable blade cartridge to a handle of such safety razor shaving systems.

### BACKGROUND

Safety razor shaving systems typically comprise a handle and a replaceable blade cartridge (often also called a disposable cartridge or simply a cartridge) in which a plurality of blades are arranged in parallel between a guard and a cap, with a connecting structure (or connecting structures) for releasably securing the cartridge to the handle, release of the cartridge from the handle being effected by a user-actuated mechanism such as a button on the handle. Often, the connecting structure of a cartridge includes a housing or an adapter that is also disposed of when the cartridge is replaced. It would therefore be desirable to provide a shaving razor system in which the material usage and/or the size of the replaceable cartridge is reduced compared to conventional safety razor systems.

### SUMMARY

One embodiment provides a safety razor shaving system comprising: a handle; a replaceable razor cartridge; and a base plate comprising an elongate frame surrounding at least one hole, wherein the elongate frame is connected to the handle and provided with engaging elements on either short side portion, the engaging elements of the elongate frame configured to releasably engage complementary engaging elements of the replaceable razor cartridge.

By making what would otherwise be a top part of the cartridge detachable allows the material usage and size of the cartridge to be reduced without adversely affecting its structural strength. This, in turn, allows the material usage and size of the packaging in which cartridges are sold to be reduced, i.e., made smaller and flatter.

In one embodiment, the replaceable razor cartridge comprises a guard, a cap, and at least one elongate blade between the guard and the cap, the replaceable razor cartridge having a lower side with a skin-contacting surface of the guard and a skin-contacting surface of the cap, and an upper side opposite to the skin-contacting surfaces of the guard and the cap; and wherein the elongate frame is configured to be mounted on the upper side of the replaceable razor cartridge with a long front portion of the elongate frame positioned vertically above the guard, a long rear portion of the elongate frame positioned vertically above the cap, and the at least one hole positioned vertically above the at least one elongate blade.

The base plate is essentially superposed on top of the cartridge when mounted, whereby the front and rear portions of the frame provide structural stability while the hole(s) allows any build-up of detritus within the cartridge to be rinsed away.

Different mechanisms for releasably securing the base plate to the cartridge can be provided.

In one embodiment, the elongate frame is provided with a pinch-release mechanism comprising a release tab on either short side portion, the release tabs configured to disengage the engaging elements of the elongate frame from the complementary engaging elements of the replaceable razor cartridge when a user-applied pinching force is applied to the release tabs. This allows for a quick and simple release of the base plate from the cartridge. For example, each of the complementary engaging elements of the replaceable razor cartridge can comprise a pair of hooks including wedges configured to force apart two portions of the respective engaging element of the elongate frame when the pinching force is applied to the release tabs.

In another embodiment, the engaging elements of the elongate frame and the complementary engaging elements of the replaceable razor cartridge comprise snap-fit joints. This is a simple mechanism for releasably securing the base plate to the cartridge. To aid the user in releasing the base plate from the cartridge, grip portions can extend from a rear side of the replaceable razor cartridge.

The base plate can sit within the body of the cartridge, i.e., the front and rear portions of the elongate frame can sit within the body of the cartridge above the guard and the cap. This provides a good interface between the base plate and the cartridge. In one embodiment, to release the base plate from the cartridge, the elongate frame is configured to bow toward the replaceable razor cartridge when a pinching force is applied to either short side portion. The base plate can therefore be easily popped out from the cartridge.

In another embodiment, one of the engaging element of the elongate frame and the complementary engaging element of the replaceable razor cartridge comprises a magnetic element, and the other one of the engaging element of the elongate frame and the complementary engaging element of the replaceable razor cartridge comprises a ferrous material. This mechanism for releasably securing the base plate to the cartridge has the advantage of no moving parts.

One embodiment provides a base plate for interconnecting a handle and a replaceable razor cartridge of a safety razor shaving system, the base plate comprising: an elongate frame surrounding at least one hole, wherein the elongate frame is provided with engaging elements on either short side portion, the releasable engaging elements of the elongate frame configured to releasably engage complementary engaging elements of the replaceable razor cartridge.

One embodiment provides a handle including the aforementioned base plate.

In any of the aforementioned embodiments, the handle can comprise an underneath surface portion facing the skin of the user in use; a front surface portion facing in the opposite direction from the shaving direction in use; a rear surface portion facing in the shaving direction in use; a top surface portion and side surface portions, one directed to either side of the blade length in use; wherein the top surface portion, underneath surface portion and side surface portions together form a continuous smooth surface which is a substantially cylindrical or substantially ellipsoid or substantially partially spherical surface; and wherein: the distance between the front surface portion and rear surface portion is between one third and three times, preferably between a half and twice, the largest dimension of the largest cross section through the continuous smooth surface.

The “chunky” bulbous shapes of the handle allow a particularly flexible ergonomic handling, giving many varied gripping positions for the human hand and easy twisting of the handle within the grip to reach different angles. The handle can alternatively be defined in terms of its bulbous shape, as comprising a handle body and a handle connecting structure; wherein the handle body is bulbous in two orthogonal directions, widening away from an end surface towards the centre of the body. This definition applies to any of the aforementioned safety razor system embodiments.

Moreover this handle shape allows the handle to stand on a surface with the blade and any lubrapad of an attached blade unit suspended above the surface. This can help prevent blade corrosion. The handle can alternatively be defined in these terms as comprising a handle body with a substantially flat end surface and a side surface (to which the handle connecting structure is attached), wherein: when the flat end surface is in contact with a horizontal plane and the cartridge is connected to the handle via the cartridge connecting structure and the handle connecting structure, the safety razor is in a stable position of rest, the flat end surface forming the safety razor's only region of contact with the plane and elevating the cartridge above the plane. This definition applies to any of the aforementioned safety razor system embodiments.

These and other features and advantages will be apparent from a reading of the following detailed description and a review of the associated drawings. It is to be understood that both the foregoing general description and the following detailed description are explanatory only and are not restrictive of the invention as claimed.

### DESCRIPTION OF FIGURES

Embodiments will now be described by way of example with reference to the accompanying drawings in which:

FIG. 1 is perspective view of a safety razor shaving system, in accordance with an embodiment of the present invention.

FIG. 2 is a perspective view of the base plate, cartridge, and handle connecting structure of the safety razor shaving system shown in FIG. 1, when the base plate is detached from the cartridge.

FIG. 3 is a perspective view of the base plate, cartridge, and handle connecting structure of the safety razor shaving system shown in FIG. 1, when the base plate is mounted on the cartridge.

FIG. 4 is a top view of the base plate, cartridge, and handle connecting structure shown in FIG. 3.

FIGS. 5A-5C are cross-sectional perspective views of the base plate and cartridge shown in FIG. 3.

FIGS. 6A-6C are cross-sectional side views of the base plate and cartridge in FIG. 3.

FIG. 7 is a perspective view of a safety razor shaving system, in accordance with another embodiment of the present invention.

FIG. 8 is a perspective view of the base plate, cartridge, and handle connecting structure of the safety razor shaving system shown in FIG. 7, when the base plate is detached from the cartridge.

FIG. 9 is a perspective view of the base plate, cartridge, and handle connecting structure of the safety razor shaving system shown in FIG. 7, when the base plate is mounted on the cartridge.

FIG. 10 is a detailed cross-sectional perspective view of the base plate and cartridge, when the base plate is detached from the cartridge as shown in FIG. 8.

FIG. 11 is a detailed cross-sectional perspective view of the base plate and cartridge, when the base plate is mounted on the cartridge as shown in FIG. 9.

FIG. 12 is a perspective view of a safety razor shaving system, in accordance with another embodiment of the present invention.

FIG. 13 is a perspective view of the base plate and cartridge of the safety razor shaving system shown in FIG. 12, when the base plate is detached from the cartridge.

FIG. 14 is a perspective view of the base plate and cartridge of the safety razor shaving system shown in FIG. 12, when the base plate is mounted on the cartridge.

FIGS. 15 is a detailed cross-sectional perspective view of the base plate and cartridge, when the base plate is mounted on the cartridge as shown in FIG. 14.

FIG. 16 is a cross-sectional perspective view of the base plate and cartridge, when the base plate is mounted on the cartridge are detached as shown in FIG. 14.

FIG. 17 is a perspective view of a safety razor shaving system, in accordance with another embodiment of the present invention.

FIG. 18 is a perspective view of the base plate and cartridge of the safety razor shaving system shown in FIG. 17, when the base plate is detached from the cartridge.

FIG. 19 is a perspective view of the base plate and cartridge of the safety razor shaving system shown in FIG. 17, when the base plate is mounted on the cartridge.

FIG. 20 is a cross-sectional perspective view of the base plate and cartridge, when the base plate is detached from the cartridge as shown in FIG. 18.

FIG. 21 is a cross-sectional perspective view of the base plate and cartridge, when the base plate is mounted on the cartridge as shown in FIG. 19.

FIG. 22 is a perspective view of a safety razor shaving system, in accordance with another embodiment of the present invention.

FIG. 23 is a perspective view of the base plate and cartridge of the safety razor shaving system shown in FIG. 22, when the base plate is mounted on the cartridge.

FIG. 24 is a top view of the base plate and cartridge of the safety razor shaving system shown in FIG. 22, when the base plate is mounted on the cartridge.

FIGS. 25 is a detailed cross-sectional perspective view of the base plate and cartridge, when the base plate is mounted on the cartridge are detached as shown in FIG. 23.

FIG. 26 is perspective view of a safety razor shaving system, in accordance with another embodiment of the present invention.

FIG. 27 is perspective view of a safety razor shaving system, in accordance with another embodiment of the present invention.

FIG. 28 is perspective view of a safety razor shaving system, in accordance with another embodiment of the present invention.

FIG. 29 is perspective view of a safety razor shaving system, in accordance with another embodiment of the present invention.

FIG. 30 is perspective view of a safety razor shaving system, in accordance with another embodiment of the present invention.

FIGS. 31 to 33 are perspective views of the handle of the safety razor shaving systems shown in FIGS. 26 to 30.

### DETAILED DESCRIPTION

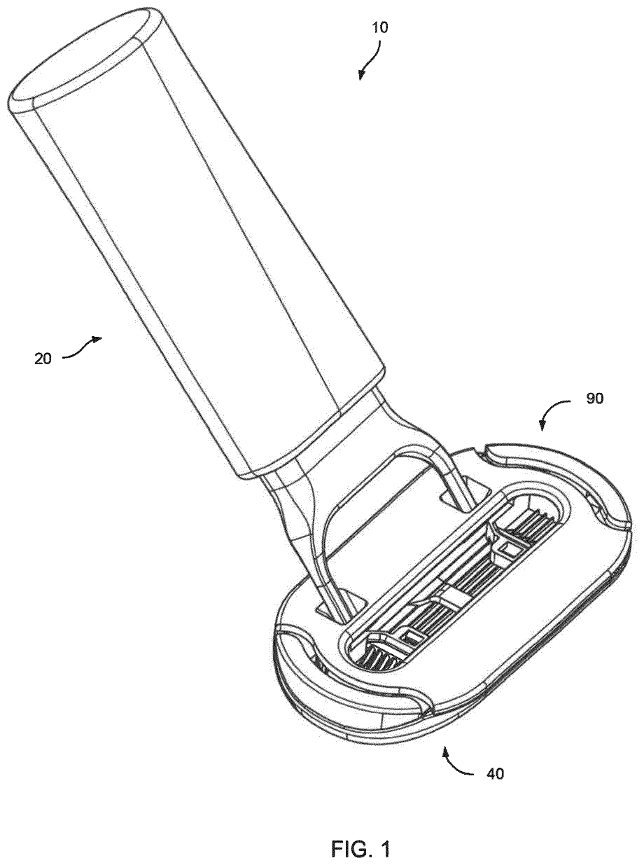

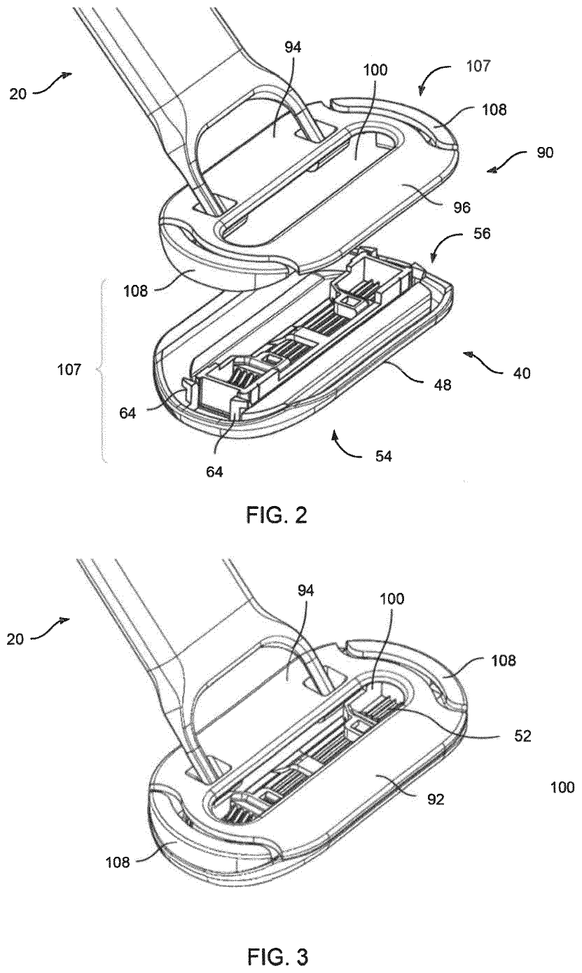

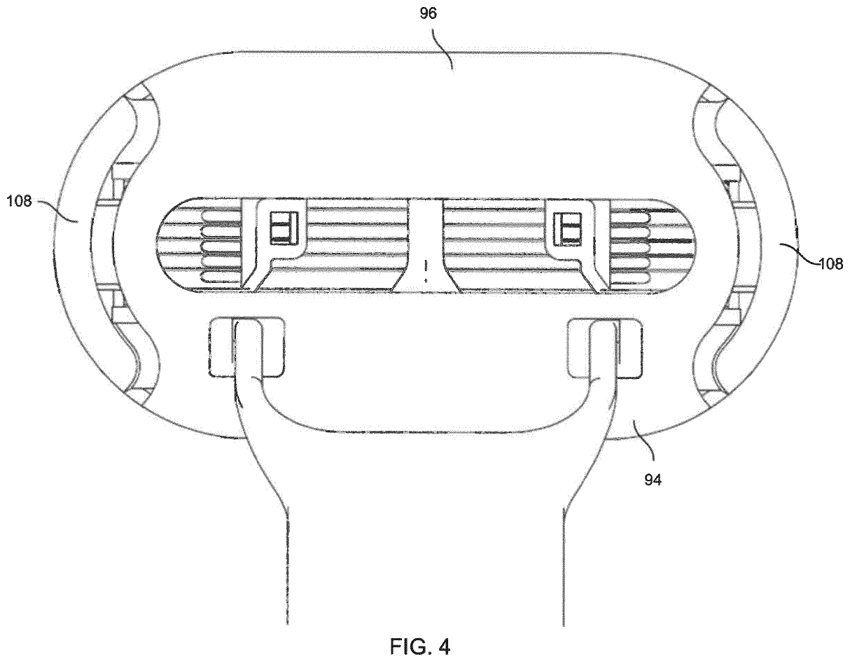

FIGS. 1 to 6C show a shaving razor system 10 comprising a handle 20, a base plate 90, and a replaceable blade cartridge 40.

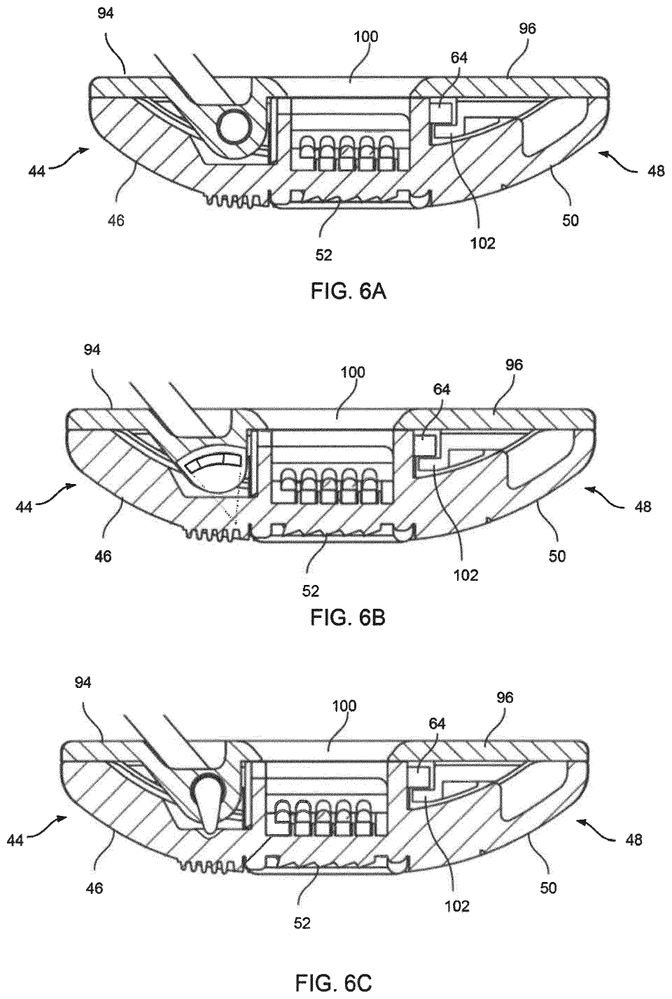

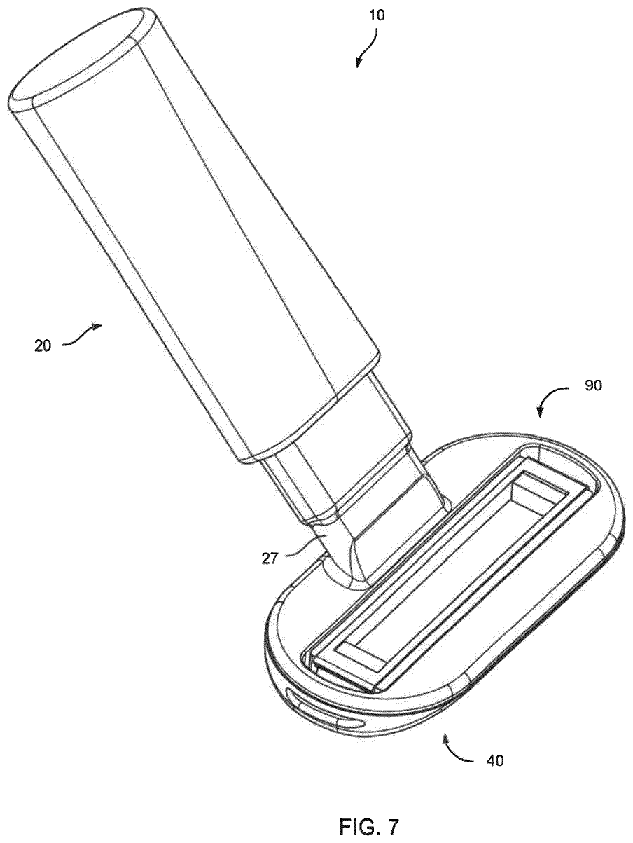

The handle 20 has a main body and a pair of parallel arms 26 that extend therefrom, with the ends of the arms 26 being pivotally attached to a base plate 90, as can best be seen in FIGS. 6a to 6B. For example, the arms 26 may have pivot pins that are mounted in the base plate 90. Of course, the arms 26 can be attached to the base plate 90 in a non-pivoting manner. The base plate 90 comprises an elongate frame 92 with a front portion 94, a rear portion 96, and two side portions 98 connecting the front and rear portions 94, 96. When portions of the elongate frame 92 are referred to as the “front” and “rear” portions, these terms are being used in relation to the shaving direction. That is, when the safety razor shaving system 10 is drawn across the skin in the shaving direction, the front portion 94 is ahead of the rear portion 96 in the shaving direction. The term “elongate” is used herein to signify that the front and rear portions 94, 96 are longer than the side portions 98, i.e., the elongate frame 98 is longer in a (longitudinal) direction perpendicular to the shaving direction than in a (transverse) direction parallel to the shaving direction. For this reason, the front and rear portions 94, 96 are also referred to herein as “long” portions and the side portions 98 as “short” portions. The elongate frame 92 surrounds a central hole 100 that allows shaving cream, hair and debris from the skin to be rinsed from the cartridge. Although in these figures the elongate frame 92 is shown surrounding one central hole 100 it will be appreciated that more than one hole can be provided.

The cartridge 40 has a guard 44, a cap 48, and one or more elongate blades 52 disposed in parallel between the guard 44 and the cap 48. For example, the cartridge 40 can have two or more (for example, five) blades. A shaving aid, such as a lubricating strip, can be incorporated in one or both of the guard 44 and the cap 48. The expressions “in front of” and “to the rear of” the blades 48 are used in the same sense as when referring to the “front” and “rear” portions of the elongate frame 92. That is, when the safety razor shaving system 10 is drawn across the skin in the shaving direction, the guard 44 is ahead of the blades 52 in the shaving direction and the cap 46 is behind the blades 52 in the shaving direction. The guard 44 and the cap 48 are connected by side portions. The cartridge 40 includes a lower side 54 and an upper side 56. The lower side 54 of the cartridge 40 includes a skin-contacting surface of the guard 44 and a skin-contacting surface of the cap 48, and it can therefore also be referred to as the skin-contacting side of the cartridge 40. The terms “upper” and “lower” are therefore used to define the sides of the cartridge relative to the shaving surface.

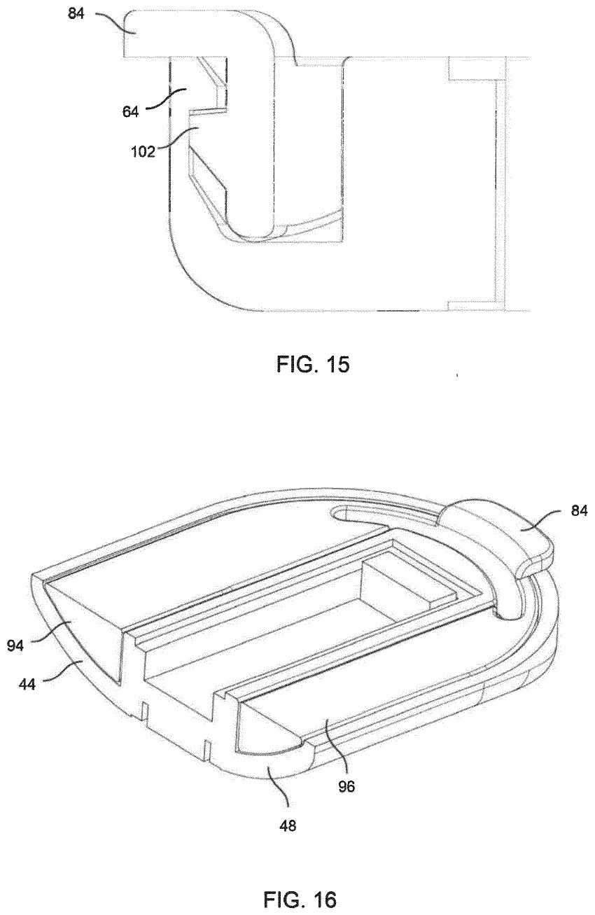

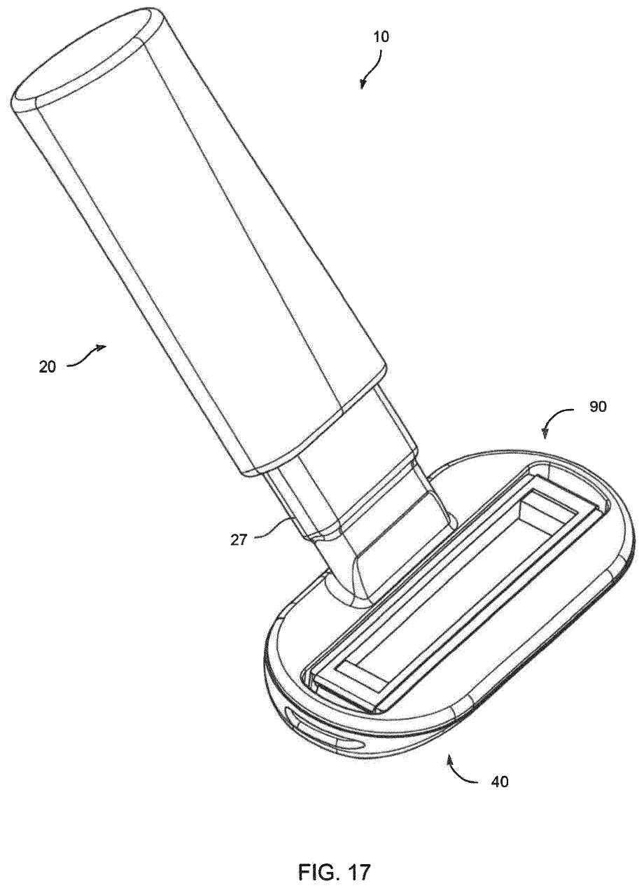

As shown in FIG. 3, the elongate frame 92 is configured to be mounted on the upper side 56 of the replaceable razor cartridge 40 with the long front portion 94 of the elongate frame 92 positioned vertically above the guard 44, the long rear portion 96 of the elongate frame 92 positioned vertically above the cap 48, and the at least one hole 100 positioned vertically above the plurality of elongate blades 52. Here “vertically above” refers to a relative position in a direction perpendicular to the shaving direction. In this embodiment, the circumferential perimeter of the base plate 90 (i.e., its ‘footprint’) matches that of the replaceable razor cartridge 40 so that the outer edges of the base plate 90 are flush with those of the replaceable razor cartridge 40. However, the circumferential perimeter of the base plate 90 could be either larger or smaller than that of the replaceable razor cartridge 40. For example, in the embodiment described with reference to FIGS. 12 to 16, the circumferential perimeter of the base plate 90 is smaller than that of the replaceable razor cartridge 40, i.e., the footprint of the base plate 90 falls within that of the replaceable razor cartridge 40. Thus, the base plate 90 can be considered to be superimposed on the cartridge 40 (possibly but not necessarily with their outer perimeters aligned) when mounted.

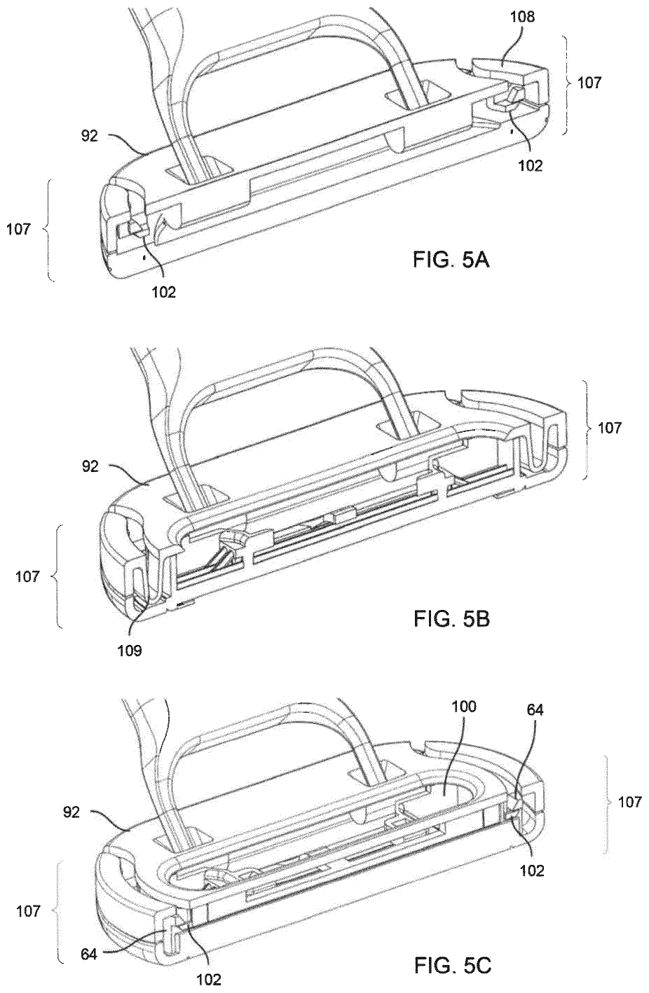

In a mounted state, engaging elements 102 of the base plate 90 engage with engaging elements 64 of the replaceable blade cartridge 40 to secure the base 90 to the replaceable blade cartridge 40. In particular, the engaging elements 64 of the cartridge 40 are formed as L-shaped hooks each having a stem connected at its lower end to the cartridge 40. The stem projects upwards from the cartridge 40 and has a tip that extends perpendicular from its upper end. The L-shaped hooks 64 are provided in pairs at either side of the cartridge 40, arranged with the open mouths facing away from each other, i.e., with one tip pointing forwards and the other tip pointing backwards. The hooks have a wedge-shaped cross section. The engaging elements 102 of the base plate 90 are formed as L-shaped projections which are slidably (in the forward and backward directions) connected to the lower surface of the base plate 90. They are also provided as pairs at the sides of the base plate 90, one engaging element per hook, and aligned therewith. As shown in FIGS. 5A, 5C and 6A to 6C, when the base plate 90 is mounted on the cartridge 40 the projection is held in the open mouth of the hook (only a portion of which is shown). The engaging elements 64, 102 can be disengaged by a pinch release mechanism 107. The pinch release mechanism 107 comprises a release element 108 and biasing element 109 that biases the release elements 107 away from each other. Thus, a pinch release mechanism 107 is provided on either short side portion 98 of the base plate 90. When a user-applied pinching force is applied to the release elements 108, the upright portions of the engaging elements 102 are urged against the wedge-shaped tips of the hooks 68, thereby forcing the engagement elements 102 apart until the lower portions of the engagement elements 102 are released from the mouth of the hooks 68.

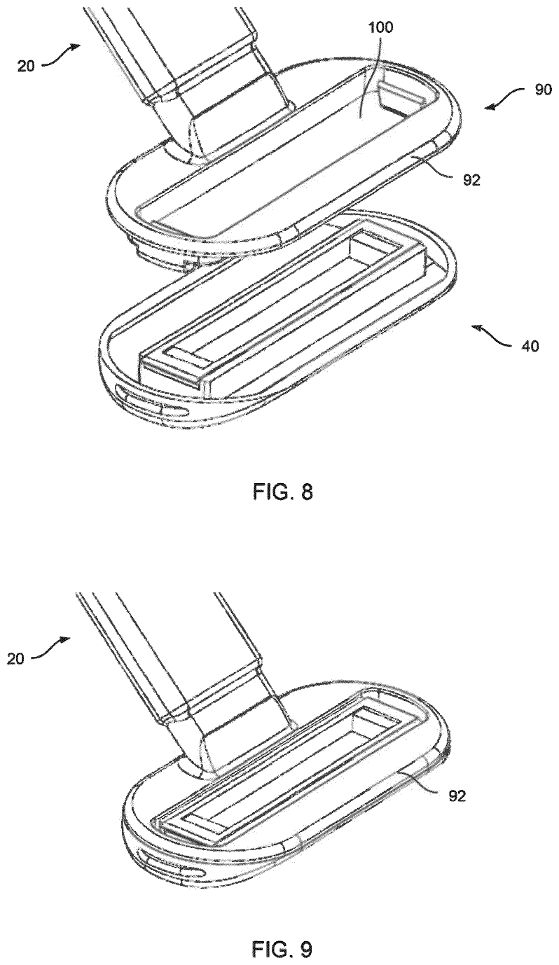

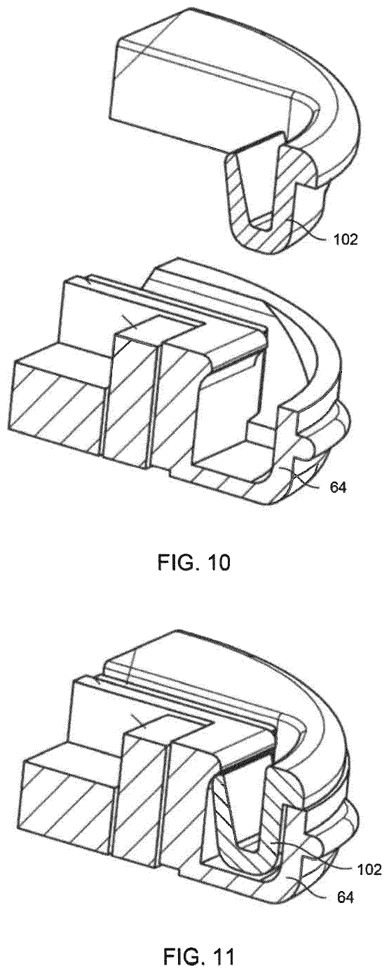

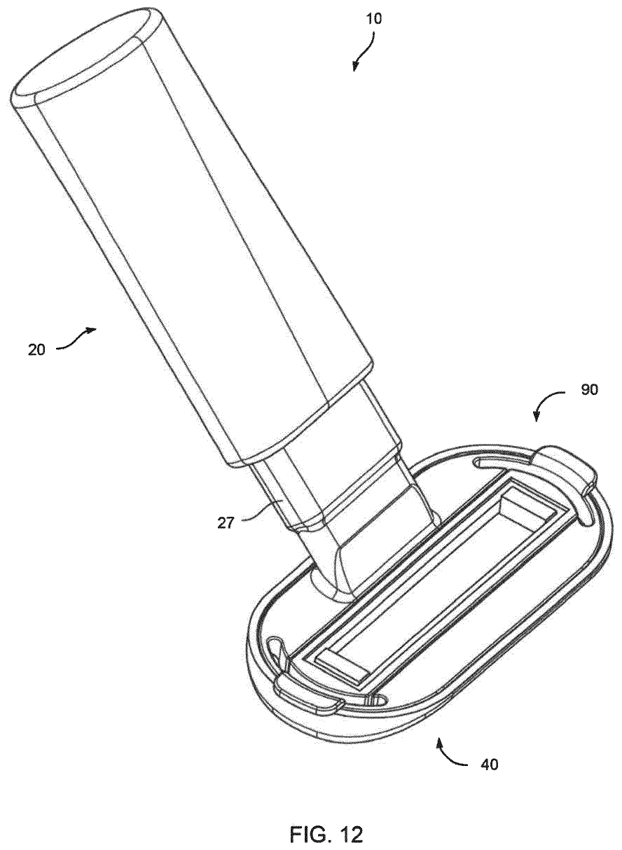

FIGS. 7 to 11 show another example of a shaving razor system 10. Like the shaving razor system 10 of FIGS. 1 to 6, the shaving razor system 10 illustrated in FIGS. 7 to 11 comprises a handle 20, a base plate 90, and a replaceable blade cartridge 40. Here, a handle stem 27 is provided instead of the arms of the shaving razor system 10 of FIGS. 1 to 6. The stem 27 can be pivotable for example by the provisions of pins (not shown) extending from end of the stem 27. Furthermore, the engaging elements 102 of the base plate 90 are snap-fit to the engaging elements 64 of the cartridge 40. As can be seen in FIGS. 10 and 11, the engaging elements 102 of the base plate are formed as U-shaped elements with one vertical limb having an outwardly overhang, and one inclined limb. The engaging element 64 of the cartridge 40 is formed as a U-shaped channel having a lip on its inner limb, and a shorter outer limb defining a rim of the cartridge 40. When the base plate 90 is mounted on the cartridge 40, the inclined limb of the base plate engaging element 64 contacts the lip of the U-shaped channel of the cartridge 40. This causes the inclined limb to flex outward (narrowing the opening of the U-shaped element). When the inclined limb passes the lip of the channel, it springs back to its original position to engage the lip. The outward overhang of the element rests on the outer limb of the channel in a flush fit. Also provided on the cartridge 40 is a gripping portion for removing the cartridge 40. To disengage the engagement elements 64, 102, the user applies a pinching force to the gripping portions.

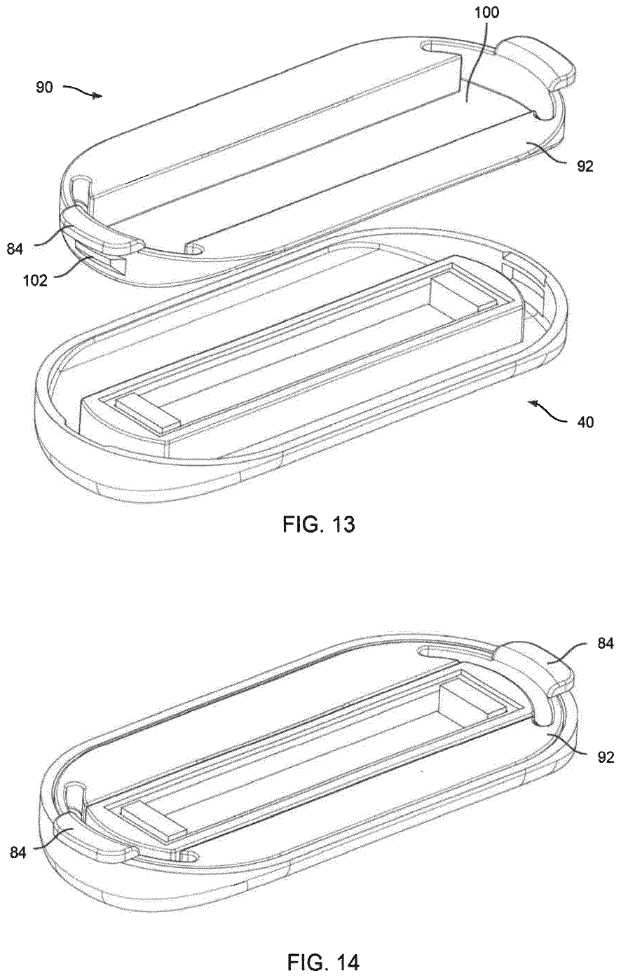

FIGS. 12 to 16 show another example of a shaving razor system 10. Like the shaving razor system 10 of FIGS. 1 to 11, the shaving razor system 10 illustrated in FIGS. 12 to 14 comprises a handle 20, a base plate 90, and a replaceable blade cartridge 40. However, in this case the footprint of the base plate 90 is smaller than that of the cartridge 40. This means that the base plate 90 sits ‘inside’ the cartridge 40 when mounted. As can be seen in FIGS. 13 and 15, the engaging elements 64, 102 comprise complementary protrusions (i.e., they form a snap fit). When the base plate 90 is mounted on the cartridge 40, the side portions of the base plate 90 flex inwards until the engaging elements 102 of the base plate 90 have passed the engaging elements 64 of the cartridge 40. The side portions of the base plate 90 then spring back to their original position so that the engaging elements 64, 102 form a snap fit. To disengage the engagement elements 64, 102, the user applies a pinching force on both of the tabs 84. This again causes the side portions of the base plate 90 to flex inwards, allowing the engaging elements 102 of the base plate 90 to be released from the engaging elements 64 of the cartridge 40. In particular, the inward flexing of the side portions of the base plate 90 causes the front and rear portions 94, 96 of the base plate 90 to bow downwards, i.e., to push against the upper surface of the base plate 90 thus forcing the cartridge 40 and base plate 90 apart.

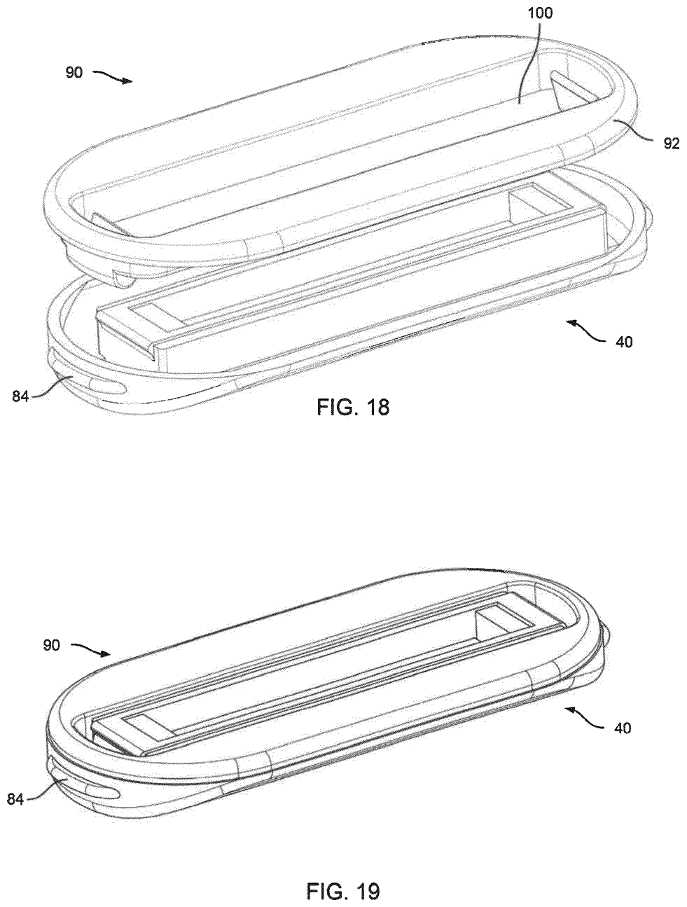

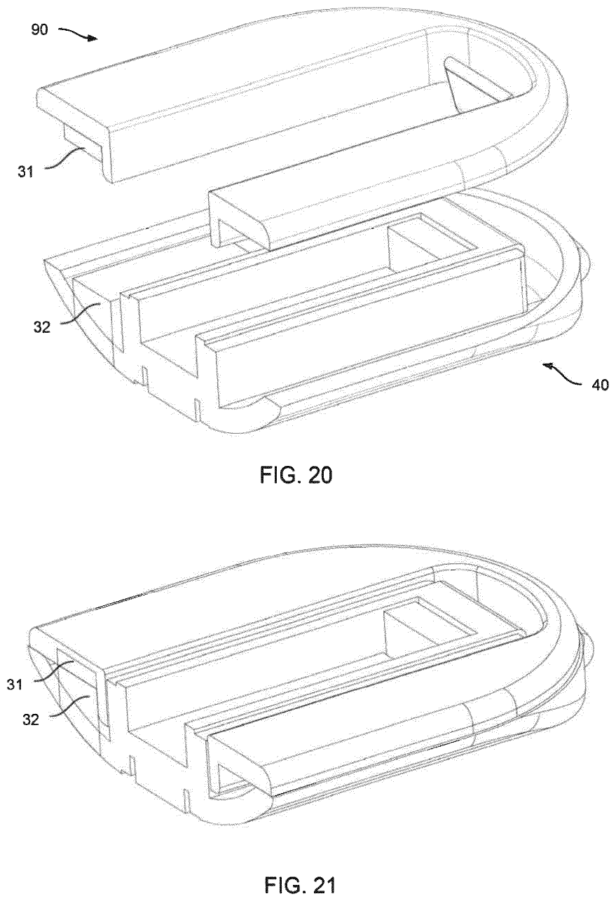

FIGS. 17 to 21 show another example of a shaving razor system 10. As in the previous examples, the shaving razor system 10 illustrated in FIGS. 17 to 21 comprises a handle 20, a base plate 90, and a replaceable blade cartridge 40. The engaging elements 64, 102 are similar to those of the system 10 shown in FIGS. 7 to 11 and will therefore not be described again. Additionally, one of the base plate 90 and the cartridge 40 has a magnetic element 31 and the other has a ferrous element 32. It will be appreciated that the base plate and cartridge can be held by the elements 31, 32 alone, i.e., without the need for the engaging elements 64, 102, though these can provide an particularly secure fit.

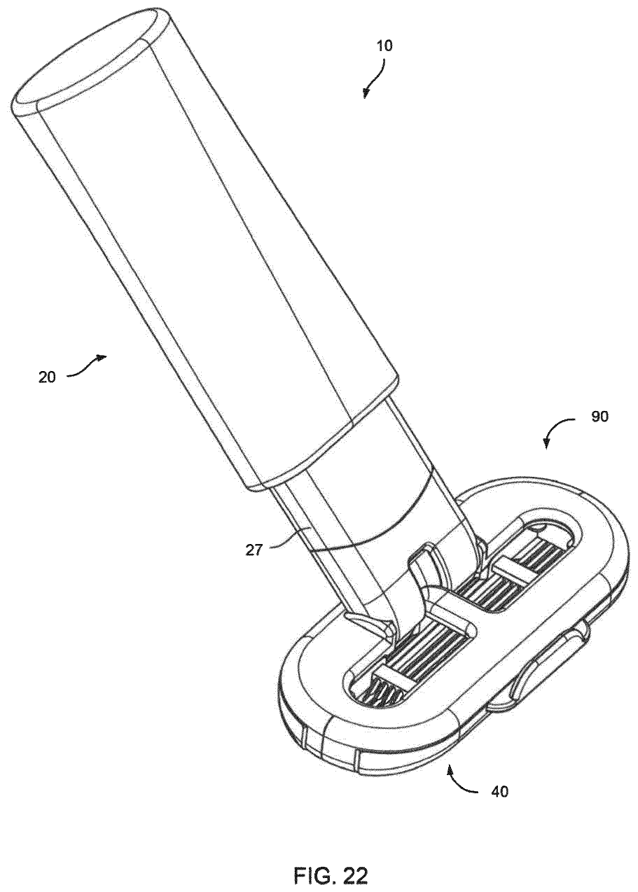

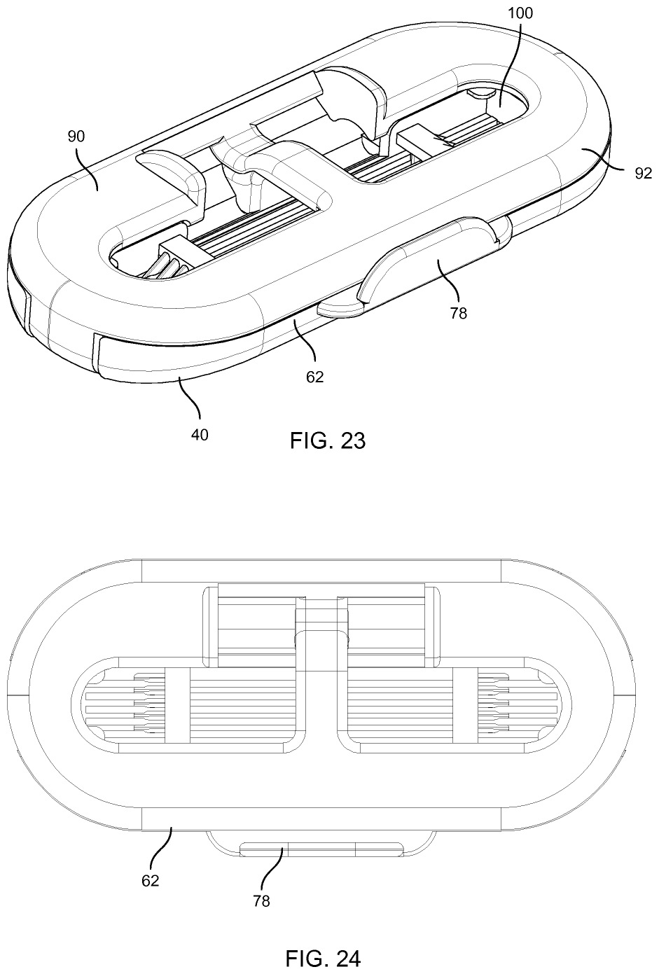

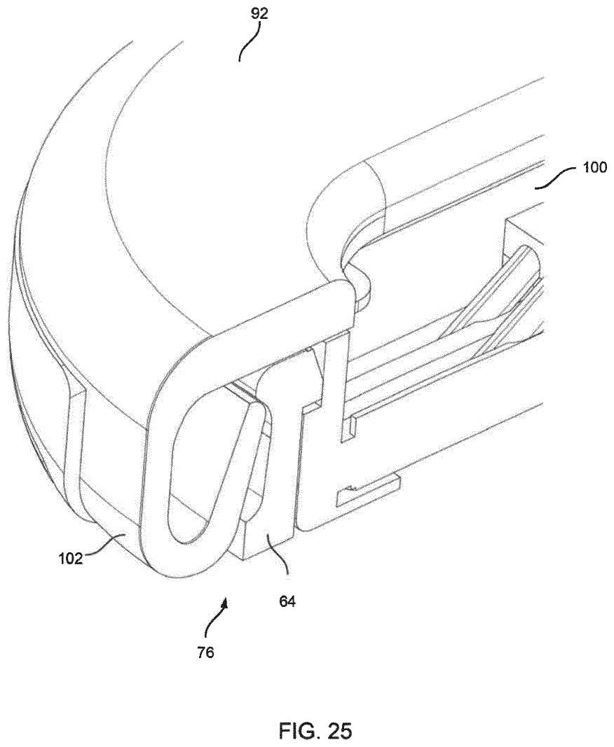

FIGS. 22 to 25 show another example of a shaving razor system 10. As in the previous examples, the shaving razor system 10 illustrated in these figures comprises a handle 20, a base plate 90, and a replaceable blade cartridge 40. Similarly, there are engagement elements 64, 102 that form a snap fit, though the configuration is somewhat different. In particular, although the engaging elements 102 of the base plate 90 are U-shaped with an inner limb that is inclined, the engaging elements 64 of the cartridge 40 are upright beams with a lip at their top. This lip engages the top of the inner limb when the base plate 90 is mounted on the cartridge 40. A rear grip portion 78 is provided on the cartridge 40 to aid the user in releasing the base plate 90 from the cartridge 40.

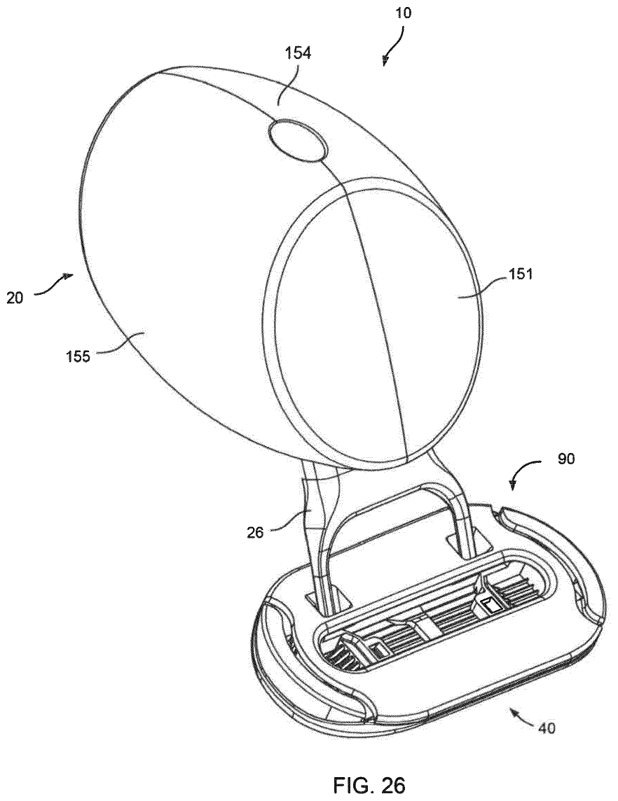

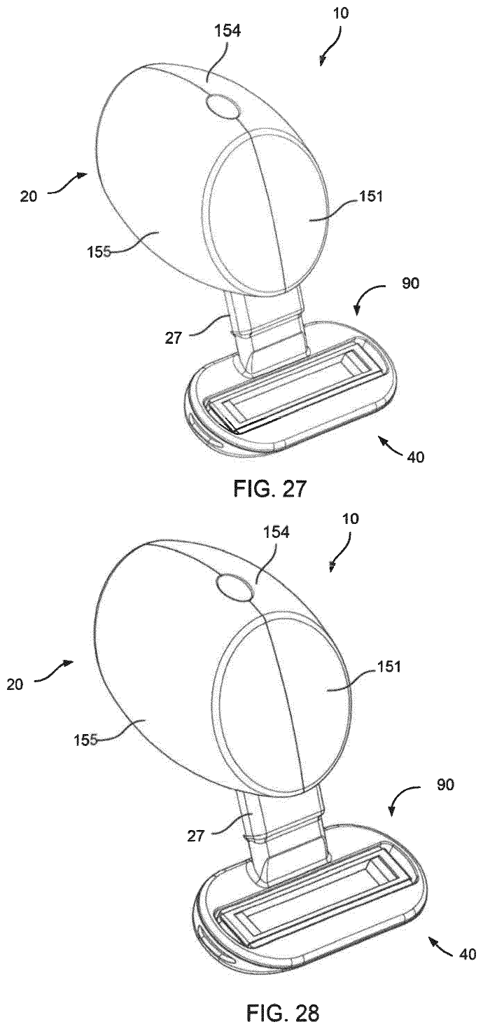

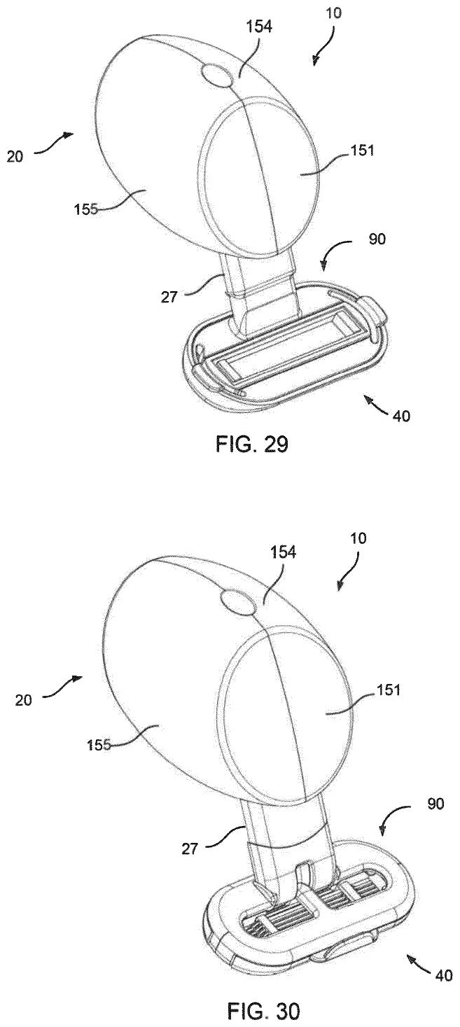

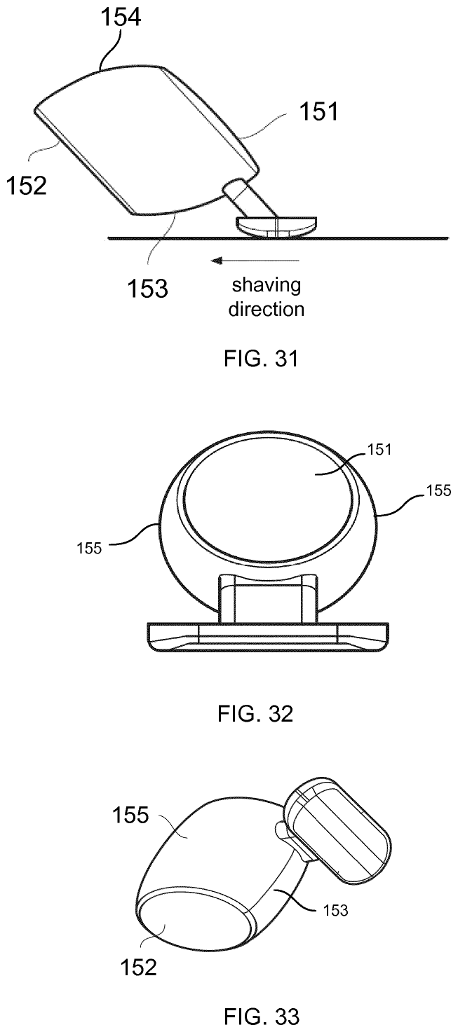

The handle depicted in FIGS. 1 to 25 is merely one of many different possible designs taken for illustration of the principle of the connecting structures. Indeed, a preferred handle that provides particularly flexible ergonomic handling (among other things) is shown in FIGS. 26 to 33. The arms 26 (or stem 27) and base plate 90 of the handle 20 shown in FIGS. 26 to 33 are generally the same as those shown in FIGS. 1 to 25. They will therefore not be described again below.

The handle 20 of the safety razor system 10 shown in FIGS. 10 to 14 has a front surface portion 151, which is flat, a rear surface portion 152 which is also flat, a curved underneath surface portion 153 to which the handle connecting structure 24 is attached, a curved top surface portion 154 and curved side surface portions 155. These curved surface portions 155 together form a continuous smooth curved surface which is circular or spherical in cross section, but may vary in shape and size along its length between the front and rear of the handle. The handle 20 may be seen as a barrel-shape, for example, with slanted ends, or a similar ellipsoid barrel shape.

Similar to the terms “upper” and “lower” used previously, the terms “underneath” is used to describe features of the handle that are positioned on the skin-contacting side, and the term “top” is used to describe features of the handle that are positioned on a side opposite the underneath side. The terms “front”, “rear”, and “side(s)” are used herein with reference to the shaving direction, similar to the expressions “in front of” and “to the rear of” the blades used previously. In particular, the term “front” means facing the shaving direction, “rear” means facing away to the shaving direction, and “side(s)” mean to either side in the shaving direction. The term substantially cylindrical or substantially ellipsoid or substantially partially spherical surface is used to describe a shape which is close to cylindrical or ellipsoid or partially spherical form, for example with a 10% deviation from one of those forms. In one measure, a section (or all sections) taken vertically through the continuous smooth surface (for example in a direction parallel to the blade length) overlaps with a circle or ellipse drawn to just cover the whole section with the areas of the circle or ellipse which are not covered by the section being up to one tenth of the area of the section.

The base of the arms 26 or the stem 27 can simply fit into a recess in the underneath surface portion 153, where it is glued or otherwise affixed in place. Of course, the handle connecting structure could alternatively be provided outside or inside the handle body via another structure that may be on (and/or inside) the side surface, or on (and/or inside) the flat end surface and the side surface.

While specific embodiments have been illustrated and described, it will be apparent to those skilled in the art that various changes and modifications may be made without departing from the invention. Accordingly, it is intended that the appended claims be interpreted as covering all such changes and modifications as fall within the true spirit and scope of the invention.

The Summary and Abstract sections may set forth one or more but not all exemplary embodiments of the present invention as contemplated by the inventor(s), and thus are not intended to limit the present invention and the appended claims in any way.

The breadth and scope of the present invention should not be limited by any of the above-described exemplary embodiments, but should be defined only in accordance with the following claims and their equivalents.

### REFERENCE LIST

10 Safety razor shaving system
20 Handle
26 Arms of handle
27 Handle stem
31 Magnetic element
32 Ferrous material
40 Cartridge
42 Cartridge connecting structure
44 Guard
46 Skin-contacting surface of guard
48 Cap
50 Skin-contacting surface of the cap
52 Blades
54 Lower side of the cartridge
56 Upper side of the cartridge
58 Transverse sides of the cartridge
60 Front side of the cartridge
62 Rear side of the cartridge
64 Engaging element(s) of the cartridge
68 Hooks
70 Vertical portion of the L-shaped hook
72 Horizontal portion of the L-shaped hook
74 Portions of the engaging element(s) of the body
76 Snap-fit joints
78 Rear Grip portion of cartridge
80 Sloped surface of guard
82 Sloped surface of cap
84 Side Grip portion of cartridge
86 Holes
90 Base plate
92 Frame
94 Front portion of the frame
96 Rear portion of the frame
98 Side portions of the frame
100 Hole
102 Engaging element(s) of the base plate
104 Sloped surface of front portion
106 Sloped surface of rear portion
107 Pinch release
108 Release element(s)
109 Biasing elements
151 Front surface portion (of handle)
152 Rear surface portion (of handle)
153 Underneath surface portion (of handle)
154 Top surface portion (of handle)
155 Side portion(s) (of handle)

1.-10. (canceled)

11. A safety razor shaving system, wherein the system comprises:
a handle;
a replaceable razor cartridge (40); and
a base plate comprising an elongate frame surrounding at least one hole, the elongate frame being connected to the handle and provided with engaging elements on either short side portion thereof, the engaging elements of the elongate frame configured to releasably engage complementary engaging elements of the replaceable razor cartridge.

12. The safety razor shaving system of claim 11, wherein the replaceable razor cartridge comprises a guard, a cap, and at least one elongate blade between the guard and the cap, the replaceable razor cartridge comprising a lower side with a skin-contacting surface of the guard and a skin-contacting surface of the cap, and an upper side opposite to the skin-contacting surfaces of the guard and the cap; and
wherein the elongate frame is configured to be mounted on the upper side of the replaceable razor cartridge with a long front portion of the elongate frame positioned vertically above the guard, a long rear portion of the elongate frame positioned vertically above the cap, and the at least one hole positioned vertically above the at least one elongate blade.

13. The safety razor shaving system of claim 11, wherein the elongate frame is provided with a pinch-release mechanism comprising a release tab on either short side portion, the release tabs configured to disengage the engaging elements of the elongate frame from the complementary engaging elements of the replaceable razor cartridge when a user-applied pinching force is applied to the release tabs.

14. The safety razor shaving system of claim 13, wherein each of the complementary engaging elements of the replaceable razor cartridge comprises a pair of hooks including wedges configured to force apart two portions of the respective engaging element of the elongate frame when the pinching force is applied to the release tabs.

15. The safety razor shaving system of claim 11, wherein the engaging elements of the elongate frame and the complementary engaging elements of the replaceable razor cartridge comprise snap-fit joints.

16. The safety razor shaving system of claim 5, wherein a grip portion extends from a rear side of the replaceable razor cartridge.

17. The safety razor shaving system of claim 12, wherein the engaging elements of the elongate frame and the complementary engaging elements of the replaceable razor cartridge comprise snap-fit joints.

18. The safety razor shaving system of claim 17, wherein a grip portion extends from a rear side of the replaceable razor cartridge.

19. The safety razor shaving system of claim 11, wherein the elongate frame is configured to bow toward the replaceable razor cartridge when a pinching force is applied to either short side portion.

20. The safety razor shaving system of claim 12, wherein the elongate frame is configured to bow toward the replaceable razor cartridge when a pinching force is applied to either short side portion.

21. The safety razor shaving system of claim 11, wherein one of the engaging elements of the elongate frame and the complementary engaging element of the replaceable razor cartridge comprises a magnetic element, and the other one of the engaging element of the elongate frame and the complementary engaging element of the replaceable razor cartridge comprises a ferrous material.

22. The safety razor shaving system of claim 12, wherein one of the engaging elements of the elongate frame and the complementary engaging element of the replaceable razor cartridge comprises a magnetic element, and the other one of the engaging element of the elongate frame and the complementary engaging element of the replaceable razor cartridge comprises a ferrous material.

23. A base plate for interconnecting a handle and a replaceable razor cartridge of a safety razor shaving system, wherein the base plate comprises:
an elongate frame surrounding at least one hole, the elongate frame being provided with engaging elements on either short side portion thereof, the releasable engaging elements of the elongate frame configured to releasably engage complementary engaging elements of the replaceable razor cartridge.

24. A handle, wherein the handle comprises the base plate of claim 23.
